(19) United States
(12) Patent Application Publication
(10) Pub. No.: US 2018/0306944 A1
(43) Pub. Date: Oct. 25, 2018

(54) Continuous Survey Using Survey Sensors

(71) Applicant: Gyrodata, Incorporated, Houston, TX (US)

(72) Inventors: Adrián Guillermo Ledroz, Houston, TX (US); John Lionel Weston, Christchurch (GB)

(21) Appl. No.: 15/874,616

(22) Filed: Jan. 18, 2018

Related U.S. Application Data
(63) Continuation-in-part of application No. 15/493,958, filed on Apr. 21, 2017.
(60) Provisional application No. 62/527,626, filed on Jun. 30, 2017.

(51) Int. Cl. G01V 11/00; E21B 47/022; E21B 47/04; G01V 3/26; G01V 3/38

(52) U.S. Cl. CPC G01V 11/002; E21B 47/02216; E21B 7/04; G01V 3/26; G01V 3/38; E21B 47/04

(57) ABSTRACT

Various implementations directed to a continuous survey using magnetic sensors are provided. In one implementation, a method may include acquiring continuous survey data during an outrun data acquisition using a survey tool disposed within a previously drilled section of a wellbore. The survey tool may have one or more magnetic sensors, and the survey tool may be configured to ascend within the previously drilled section of the wellbore during the outrun data acquisition. The method may further include transmitting the continuous survey data to a computing system, where the computing system may be configured to generate a continuous survey of the previously drilled section of the wellbore based on the continuous survey data.

### CROSS-REFERENCE TO RELATED APPLICATIONS

This application claims the benefit of priority to U.S. Provisional Patent Application No. 62/527,626, filed Jun. 30, 2017, and is a continuation-in-part of U.S. patent application Ser. No. 15/493,958, filed Apr. 21, 2017, each of which are herein incorporated by reference.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

A survey tool can be equipped with survey instrumentation, such as measurement while drilling (MWD) instrumentation, which provides information regarding the orientation of the survey tool, and hence, the orientation of the well at the tool location. Survey instrumentation can make use of various measured quantities such as one or more of acceleration, magnetic field, and angular rate to determine the orientation of the tool and the associated wellbore with respect to a reference vector such as the Earth's gravitational field, magnetic field, or rotation vector. The determination of such directional information at generally regular intervals along the path of the well can be combined with measurements of well depth to allow the trajectory of the well to be determined.

### SUMMARY

Described herein are implementations of various technologies relating to a continuous survey using magnetic sensors. In one implementation, a method may include acquiring continuous survey data during an outrun data acquisition using a survey tool disposed within a previously drilled section of a wellbore. The survey tool may have one or more magnetic sensors, and the survey tool may be configured to ascend within the previously drilled section of the wellbore during the outrun data acquisition. The method may further include transmitting the continuous survey data to a computing system, where the computing system may be configured to generate a continuous survey of the previously drilled section of the wellbore based on the continuous survey data.

In another implementation, a method may include receiving continuous survey data acquired during an outrun data acquisition using a survey tool disposed within a previously drilled section of a wellbore. The survey tool may have one or more magnetic sensors, and the survey tool may be configured to ascend within the previously drilled section of the wellbore during the outrun data acquisition. The method may also include generating a continuous survey of the previously drilled section of the wellbore based on the continuous survey data.

In yet another implementation, a system may include a survey tool disposed in a previously drilled section of a wellbore. The survey tool may include one or more magnetic sensors configured to acquire continuous survey data during an outrun data acquisition using the drop survey tool, where the survey tool may be configured to ascend within the previously drilled section of the wellbore during the outrun data acquisition. The system may also include a processor, and may include a memory having a plurality of program instructions which, when executed by the processor, cause the processor to receive the continuous survey data acquired during the outrun data acquisition, and to generate a continuous survey of the previously drilled section of the wellbore based on the continuous survey data.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a schematic diagram of a gyrocompassing survey operation in accordance with implementations of various techniques described herein.

FIG. 2 illustrates a flow diagram of a method for generating a continuous survey of a wellbore in accordance with implementations of various techniques described herein.

FIG. 3 illustrates a schematic diagram of a gyrocompassing survey operation in accordance with implementations of various techniques described herein.

FIG. 4 illustrates a flow diagram of a method for generating a continuous survey of a wellbore in accordance with implementations of various techniques described herein.

FIG. 5 illustrates a schematic diagram of a drilling operation in accordance with implementations of various techniques described herein.

FIG. 6 illustrates a flow diagram of a method for generating a continuous survey of a wellbore in accordance with implementations of various techniques described herein.

FIG. 7 illustrates a schematic diagram of a computing system in which the various technologies described herein may be incorporated and practiced.

### DETAILED DESCRIPTION

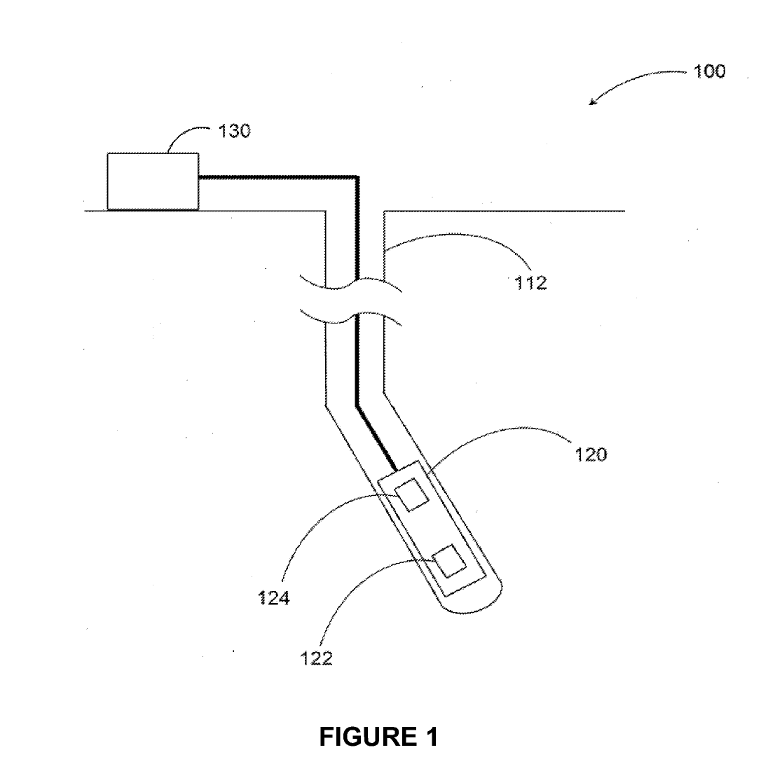

Various implementations directed to a continuous survey using magnetic sensors will now be described in the following paragraphs with reference to at least FIGS. 1-4.

To obtain hydrocarbons such as oil and gas, directional wellbores may be drilled through Earth formations along a selected trajectory. The selected trajectory may deviate from a vertical direction relative to the Earth at one or more inclination angles and at one or more azimuth directions with respect to a true north along the length of the wellbore. As such, measurements of the inclination and azimuth of the wellbore may be obtained to determine a trajectory of the directional wellbore.

It may be desirable to accurately determine the true path or trajectory of a previously drilled wellbore, including portions of the wellbore having significant deviations from a predetermined plan for the wellbore path. Different drilling methods may result in more deviations than others (e.g., paths that have more tortuous trajectories than others), and detailed data regarding the wellbore path or trajectory which take account of short-term perturbations in the wellbore path may be desirable for a number of reasons. Such reasons may include the identification of low-tortuosity sections for permanent installation of completion or production equipment, and the identification of high-tortuosity sections in which rod guide wear sleeve equipment is to be placed to increase rod and casing life and to reduce workover frequency. Furthermore, detailed knowledge of well tortuosity may help the evaluation of the drilling equipment and process, in particular the steering while drilling performance, and for extended reach drilling.

To determine the trajectory of a wellbore, as is known in the art, a directional survey may be performed to measure the inclination and azimuth at selected positions along the wellbore. In particular, a survey tool may be used within the wellbore to determine the inclination and azimuth along the wellbore. The survey tool may include sensors configured to generate measurements corresponding to the instrument orientation with respect to one or more reference directions, to the Earth's magnetic field, and/or to the Earth's gravity, where the measurements may be used to determine azimuth and inclination along the wellbore.

For example, the survey tool may include one or more accelerometers configured to measure one or more components of the Earth's gravity, where these measurements may be used to generate an inclination angle and a toolface angle of the survey tool. In addition, the survey tool may include one or more magnetic sensors configured to measure one or more components of the Earth's magnetic field, where the measurements may be used to determine an azimuth and inclination along the wellbore.

In various implementations further described below, a survey tool disposed in a previously drilled section of the wellbore may be used to acquire continuous survey data during an outrun data acquisition using one or more magnetic sensors and one or more accelerometers. The survey tool may be a MWD survey tool, a drop survey tool, a wireline survey tool, a slickline survey tool, or any other survey tool known to those skilled in the art. An outrun data acquisition may refer to a data acquisition performed as a survey tool is extracted from at least the previously drilled section of the wellbore. In particular, as further described below, during the outrun data acquisition, the survey tool may record the continuous survey data as it ascends within the previously drilled section of the wellbore. The continuous survey data may be used to generate a continuous survey of the wellbore, which may be used to determine the true path or trajectory of the wellbore.

Measurement while Drilling (MWD) Survey Tool

FIG. 1 illustrates a schematic diagram of a gyrocompassing survey operation 100 in accordance with implementations of various techniques described herein. As shown, the gyrocompassing survey operation may be performed using a survey tool 120 and a computing system 130.

The survey tool 120 may be disposed within a wellbore 112, and may be used in conjunction with various applications, as discussed below. The survey tool 120 may be part of a downhole portion (e.g., a bottom hole assembly) of a drill string (not pictured) within the wellbore 112. In particular, the survey tool 120 may be a measurement while drilling (MWD) survey tool, where it may be part of a MWD drill string used to drill the wellbore 112. In conventional systems, the MWD survey tool 120 may be used to acquire measurements while the drill string is drilling the wellbore 112 and being extended downwardly along the wellbore 112.

The survey tool 120 may include one or more magnetic sensors 122, one or more accelerometers 124, and any other sensors known to those skilled in the art. The one or more magnetic sensors 122 may be used to measure the direction and magnitude of the local magnetic field vectors in order to measure the azimuth and/or the inclination at various survey stations along the wellbore 112, as is known to those skilled in the art. In particular, the magnetic sensors 122 may be configured to measure one or more orthogonal and/or non-orthogonal components of the Earth's magnetic field. For example, the survey tool 120 may include three magnetic sensors 122 configured to measure the orthogonal components (bₓ, b_{y}, b_{z}) of the Earth's magnetic field with respect to the x-axis, the y-axis, and the z-axis of the survey tool 120. The one or more magnetic sensors 122 may include any magnetic sensor known to those skilled in the art, including flux gate sensors, solid state devices, and/or the like.

The one or more accelerometers 124 may be configured to measure one or more orthogonal and/or non-orthogonal components of the Earth's gravity, where these measurements may be used to generate an inclination angle and a toolface angle of the survey tool 120, as is known to those skilled in the art. For example, the one or more acceleration sensors 124 may include three single-axis accelerometers configured to provide measurements of the orthogonal components (gₓ, g_{y}, g_{z}) of the Earth's gravitation vector with respect to the x, y, and z axes of the survey tool 120.

Various types of accelerometers may be used, such as quartz flexure accelerometers, MEMS accelerometer devices, and/or any other type of accelerometers known to those skilled in the art. In one implementation, the measurement range of the accelerometers may be in excess of ±1 unit of standard gravity (g) (e.g., in a range between ±1.2 g and ±1.5 g). Further, the accelerometers may be of a size that can be accommodated in a downhole tool (e.g., within the confines of a 1 and ¾ inch pressure case of a wellbore), capable of operating over an expected temperature range (e.g., −20° C. to +150° C., or greater), and capable of surviving the downhole vibration and shock environment that may be encountered during the drilling process. The resolution and precision of the one or more accelerometer sensors can depend on the time and the desired angular rate uncertainty. For example, for errors below a maximum error on a toolface rate of 0.05°/hour over 15 seconds, the at least one accelerometer can provide noise levels below 0.14 mg. An analog-to-digital system with a range of ±1.2 g and 16 bits can give a resolution of 0.036 mg/count, which can satisfy the desired noise levels. If the time is increased, the accelerometer uncertainty can be increased as well.

As noted above, in conventional systems, the MWD survey tool 120 may be used to acquire survey data while the drill string is drilling the wellbore 112 and being extended downwardly along the wellbore 112. In particular, the survey tool 120 may be used to acquire survey data during an inrun data acquisition using the one or more magnetic sensors 122 and the one or more accelerometers 124. An inrun data acquisition may refer to a data acquisition performed as a survey tool is inserted into a wellbore. However, the situation downhole may not be known precisely, and failure of the survey tool 120 to become stationary when survey data are collected during the inrun data acquisition may degrade the accuracy of a wellbore survey generated using this survey data.

As such, various implementations described herein may be used to acquire continuous survey data during an outrun data acquisition using the survey tool 120, where the continuous survey data may be used to generate a continuous survey of a previously drilled section of the wellbore 112 in order to determine the true path or trajectory of the previously drilled section of the wellbore 112.

After a period of drilling using the drill string has ceased, the survey tool 120 may be disposed in the previously drilled section of the wellbore 112. A portion of the drill string may be retrieved thereafter, such as to inspect and/or repair a portion of the bottom hole assembly. During the retrieval of the drill string, the survey tool 120 is raised within the wellbore 112 to the surface or to a higher position within the wellbore, placing the survey tool 120 at multiple positions of different depths with respect to the Earth as the drill string ascends the wellbore 112.

Accordingly, the survey tool 120 may be configured to acquire continuous survey data during an outrun data acquisition as the drill string is being retrieved from the wellbore 112, during which the tool 120 may record the continuous survey data at the multiple positions (i.e., survey stations) within the wellbore 112 and store that data in an electronic memory device (not pictured) of the survey tool 120. The data recorded by the tool 120 as the tool 120 ascends the wellbore 112 may correspond to continuous survey measurements acquired using the one or more magnetic sensors 122, the one or more accelerometers 124, and any other sensors of the survey tool 120.

In particular, the survey data may be acquired using these sensors at discrete intervals (i.e., survey stations) as the drill string is being retrieved from the wellbore 112. Although the survey data is acquired at discrete intervals, the discrete intervals may be set to a value such that the survey data effectively corresponds to “continuous” survey data for a previously drilled section of the wellbore 112. As such, the survey data acquired using the implementations discussed herein are referred to as “continuous survey data”.

For example, the discrete intervals may be set to be no greater than every one foot along the wellbore 112. In other examples, discrete intervals of three feet, five feet, and so forth may be used. A data sampling (i.e., acquisition) frequency of the survey tool 120 may be set to a particular value in order to assure that the survey tool 120 acquires the continuous survey data at particular discrete intervals (e.g. every one foot). The setting of the data sampling frequency of the tool 120 may depend on the rate of ascent of the tool 120 within the drill string. In particular, the faster that the tool 120 moves within the drill string, then the higher the data sampling frequency should be in order to assure that the survey tool 120 acquires the continuous survey data at the particular discrete intervals.

As discussed in greater detail below, the continuous survey data may be used to determine a toolface angle, an inclination angle, and azimuth for each survey station along the wellbore as the tool 120 ascends within the wellbore 112. In another implementation, the continuous survey data may include measured changes in inclination and azimuth between each survey station along the wellbore as the tool 120 ascends within the wellbore 112.

In addition, the continuous survey data also includes depth data acquired by the survey tool 120 during the outrun data acquisition. In one implementation, the depth of the survey tool 120 (i.e., the depth data) at the survey stations for the continuous survey data recorded during the outrun data acquisition can be determined based on the known lengths of the drill string and of each section of the drill string that is pulled out during the retrieval process.

In one such implementation, in addition to the known lengths of the drill string and of each section of the drill string that is pulled out during the retrieval process, the depth of the survey tool 120 (i.e., the depth data) at the survey stations can be determined based on the assumption that the rate of ascent of the drill string during retrieval is substantially constant. In another implementation, in addition to the known lengths of the drill string and of each section of the drill string that is pulled out during the retrieval process, the depth of the survey tool 120 (i.e., the depth data) at the survey stations can also be determined using the one or more accelerometers 124. In particular, the one or more accelerometers 124 may include a z-axis accelerometer configured to provide measurements of the acceleration along a longitudinal axis (i.e., z-axis) of the survey tool. As such, the z-axis accelerometer may be used to determine the depth of the survey tool 120 at the survey stations for the continuous survey data, irrespective of the rate of ascent for the tool 120 during retrieval. Specifically, the measurements acquired using the z-axis accelerometer may be integrated in order to determine the depth of the survey tool 120 at the survey stations.

In one implementation, prior to the retrieval of the survey tool 120, a computing system (not shown) of the survey tool 120 may receive a mode signal indicating that the survey tool is to switch to a continuous survey mode, during which the continuous survey data can be acquired. In a further implementation, the computing system 130 may transmit the mode signal to the computing system of the survey tool 120. The computing system 130 is discussed in further detail in a later section.

The mode signal may be communicated to the survey tool 120 using any form of downhole communication known to those skilled in the art. In one implementation, the mode signal may be transmitted to the survey tool 120 using mud pulse telemetry. For example, the computing system 130 may use a pulser unit to transmit the mode signal by varying the drilling fluid (mud) pressure inside the drill string. Downhole pressure transducers may measure these pressure fluctuations (pulses) and pass an analog form of the mode signal to the computing system of the survey tool 120, where the received analog signal may be digitized. Other forms of downhole communication used to transmit the mode signal to the computing system of the survey tool 120 may include any form of electromagnetic communication, acoustic communication, and/or the like known to those skilled in the art.

In some implementations, the survey tool 120 may initially be in a stationary survey mode, during which the survey tool 120 is configured to acquire stationary survey data during the inrun data acquisition. In such implementations, the mode signal may be used to switch the survey tool 120 from the stationary survey mode to the continuous survey mode prior to the retrieval of the survey tool 120 and the outrun data acquisition.

The computing system 130 may be used to process the data acquired by the survey tool 120 during the outrun data acquisition, as further described below. In particular, based on the acquired data, the computing system 130 may be used to generate a continuous survey of the wellbore 112. In one implementation, the computing system 130 may be located at the surface, and may be configured to receive or download the recorded data from the tool 120 after the tool 120 has been retrieved from the wellbore 112 using any form of communications known to those skilled in the art. In another implementation, the computing system 130 may be configured to receive or download the acquired data from the tool 120 as the tool 120 traverses the wellbore 112, such as through the communication implementations described above for transmitting the mode signal. The computing system 130 can be any computing system implementation known to those skilled in the art. Various implementations of the computing system 130 and the computing system of the survey tool 120 are further discussed in a later section.

As noted above, in one implementation, the computing system 130 may use the continuous survey data to determine a toolface angle, an inclination angle, and azimuth for each survey station along the wellbore 112. In particular, the toolface angle, the inclination angle, and the azimuth of the wellbore 112 may be determined for each survey station using the following equations:

$$\begin{matrix}α = arctan [ \frac{- {g}_{x}}{- {g}_{y}} ] & ( 1 ) \\ I = arctan [ \frac{\sqrt{{g}_{x}^{2} + {g}_{y}^{2}}}{{g}_{z}} ] & ( 2 ) \\ A = arctan [ \frac{( {g}_{x} {b}_{y} - {g}_{y} {b}_{x} ) \sqrt{{g}_{x}^{2} + {g}_{y}^{2} + {g}_{z}^{2}}}{{b}_{z} ( {g}_{x}^{2} + {g}_{y}^{2} ) - {g}_{z} ( {g}_{x} {b}_{x} + {g}_{y} {b}_{y} )} ] & ( 3 )\end{matrix}$$

where α represents the toolface angle, l represents the inclination angle, gₓ, g_{y}, and g_{z} represent the measured orthogonal components of the Earth's gravitation vector for the survey station, and bₓ, b_{y}, and b_{z} represent the measured orthogonal components of the Earth's magnetic vector for the survey station. In a further implementation, the computing system may generate a continuous survey of the previously drilled section of the wellbore by plotting the determined azimuth and inclination angle versus depth for all of the survey stations. The continuous survey may then provide information regarding the trajectory, and thus tortuosity, of the previously drilled section of the wellbore.

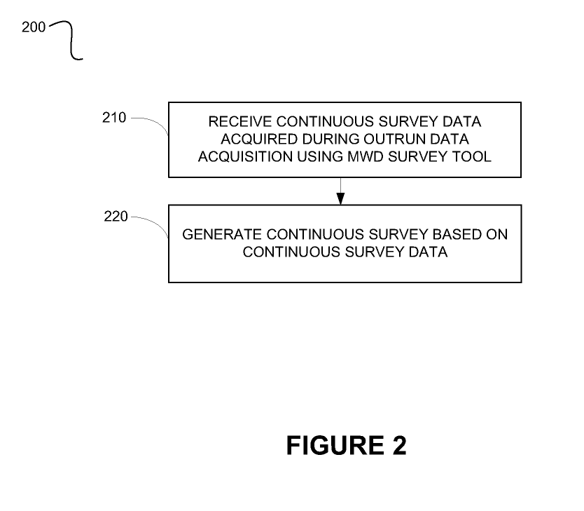

FIG. 2 illustrates a flow diagram of a method 200 for generating a continuous survey of a wellbore in accordance with implementations of various techniques described herein. In one implementation, method 200 may be at least partially performed by a computing system, such as the computing system 130 discussed above. It should be understood that while method 200 indicates a particular order of execution of operations, in some implementations, certain portions of the operations might be executed in a different order. Further, in some implementations, additional operations or steps may be added to the method 200. Likewise, some operations or steps may be omitted.

At block 210, the computing system may receive continuous survey data acquired during an outrun data acquisition of a previously drilled section of a wellbore using a MWD survey tool, where the MWD survey tool is configured to acquire the continuous survey data as the tool ascends within the previously drilled section of the wellbore during the outrun data acquisition. In particular, the continuous survey data may be data corresponding to a plurality of continuous survey measurements acquired during the outrun data acquisition.

As noted above, the survey tool may be configured to perform the outrun data acquisition as the drill string is being retrieved from the wellbore, during which the tool records continuous survey data at multiple survey stations within the wellbore and stores that data in an electronic memory device of the survey tool. As also noted above, the continuous survey data may be acquired at discrete intervals (i.e., survey stations) as the drill string is being retrieved from the wellbore. In one implementation, such intervals may be no greater than every 1 foot along the wellbore.

The continuous survey data may be acquired using one or more magnetic sensors, one or more accelerometers, and any other sensors of the survey tool. The continuous survey data also includes depth data acquired during the outrun data acquisition, where the depth data corresponds to depth of the survey tool at the survey stations for the continuous survey data. The depth data can be determined based on the known lengths of the drill string and of each section of the drill string that is pulled out during the retrieval process. In addition, prior to the retrieval of the survey tool, a computing system (not shown) of the survey tool may receive a mode signal indicating that the survey tool is to switch to a continuous survey mode, during which the continuous survey data can be acquired.

At block 220, the computing system may generate a continuous survey of the previously drilled section of the wellbore based on the continuous survey data. In particular, as is known to those skilled in the art, the continuous survey data may be plotted to produce a continuous survey of the wellbore, where the continuous survey provides information regarding the trajectory, and thus tortuosity, of the wellbore. The continuous survey of the wellbore may provide information regarding the trajectory of the wellbore at the survey stations along the wellbore.

In another implementation, the continuous survey data may also include multiple measurements for the same position within the wellbore. In particular, as is known in the art, the drill string may be composed of multiple sections threadably coupled together. As such, during the retrieval of the drill string during an outrun data acquisition, one section of the drill string is pulled out of the wellbore 112 (i.e., recovered), and movement of the drill string is momentarily stabilized. The recovered section of the drill string is then unthreaded from the drill string, and the same retrieval process is repeated for subsequent sections of the drill string. Accordingly, multiple magnetic survey measurements may be acquired when the drill string is momentarily stabilized at a particular position in the wellbore during the retrieval process. In such an implementation, the computing system may calculate an average of these multiple measurements, and then use this average when generating the continuous survey of the wellbore.

In another implementation, the computing system may generate the continuous survey of the wellbore based on the continuous survey data acquired during the outrun data acquisition and the stationary survey data acquired during the inrun data acquisition. Any implementation for generating the continuous survey based on the continuous survey data and the stationary survey data may be used, such as the method for combining the continuous survey data and the stationary survey data disclosed in commonly assigned U.S. patent application Ser. No. 14/446,140, which is herein incorporated by reference.

### Drop Survey Tool

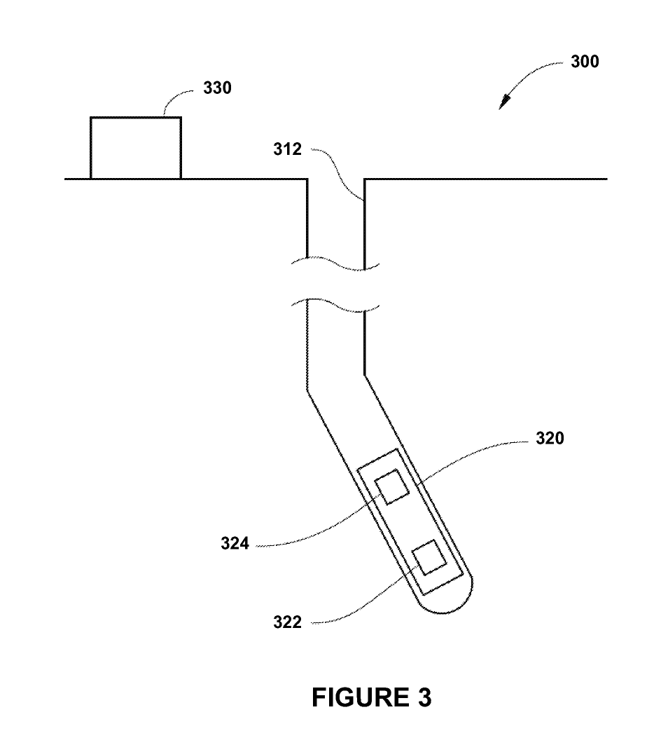

FIG. 3 illustrates a schematic diagram of a gyrocompassing survey operation 300 in accordance with implementations of various techniques described herein. As shown, the gyrocompassing survey operation may be performed using a drop survey tool 320 and a computing system 330.

The drop survey tool 320 may be similar to the survey tool discussed above. The drop survey tool 320 may be disposed within a wellbore 312, and may be used in conjunction with various applications, as discussed below. The drop survey tool 320 may also include one or more magnetic sensors 322 and one or more accelerometers 324. The one or more magnetic sensors 322 and the one or more accelerometers 324 may be similar to those discussed above with respect to FIG. 1. As is known in the art, the drop survey tool 320 may be uncoupled from the surface, and may be powered using one or more batteries. Any drop survey tool 320 known to those skilled in the art and configured to carry out the implementations described below may be used.

Initially, the drop survey tool 320 may be dropped into a drill string (not pictured) of the wellbore 312. The drop survey tool 320 may be configured to land at the bottom of the drill string, such as in an area proximate to a bottom hole assembly of the drill string. In one implementation, the drop survey tool 320 may include a spring mounted to the bottom of the tool and/or any other implementation known in the art that may be used to minimize levels of shock and vibration for the tool 320 as it travels down the wellbore and lands within the drill string.

After landing within the drill string, various implementations described herein may be used to acquire continuous survey data during an outrun data acquisition using the survey tool 320, where the continuous survey data may be used to generate a continuous survey of a previously drilled section of the wellbore 312 in order to determine the true path or trajectory of the previously drilled section of the wellbore 312.

As similarly discussed above with respect to the MWD survey tool, after a period of time, the drill string may be retrieved, such as for the inspection or replacement of a drill bit coupled to the bottom of the drill string. During the retrieval of the drill string, the drop survey tool 320 positioned at the bottom of the drill string is raised within the wellbore 312 and placed in multiple positions of different depths with respect to the Earth as the drill string ascends the wellbore 312.

Accordingly, as similarly discussed above with respect to the MWD survey tool, the survey tool 320 may be configured to acquire continuous survey data during an outrun data acquisition as the drill string is being retrieved from the wellbore 312, during which the tool 320 may record the continuous survey data at the multiple positions (i.e., survey stations) within the wellbore 312 and store that data in an electronic memory device (not pictured) of the survey tool 320. In particular, the data recorded by the tool 320 as the tool 320 ascends the wellbore 312 may correspond to continuous survey measurements acquired using the one or more magnetic sensors 322, the one or more accelerometers 324, and any other sensors of the survey tool 320.

In particular, the continuous survey data may be acquired using these sensors at discrete intervals (i.e., survey stations) as the drill string is being retrieved from the wellbore 312. For example, the discrete intervals may be set to be no greater than every one foot along the wellbore 312. In other examples, discrete intervals of three feet, five feet, and so forth may be used. In another implementation, the continuous survey data may include measured changes in inclination and azimuth between each survey station along the wellbore as the tool 320 ascends within the wellbore 312. In addition, the continuous survey data also includes depth data acquired by the survey tool 320 during the outrun data acquisition, which can be determined using the same implementations discussed above for the MWD survey tool.

In one implementation, prior to dropping the drop survey tool 320 within the drill string, the survey tool may be switched to a continuous survey mode, during which the continuous survey data can be acquired. In another implementation, the drop survey tool 720 may include a computing system (not shown), which may switch the drop survey tool 720 to the continuous survey mode after the survey 320 has landed within the drill string. In one such implementation, the tool 320 may switch to the continuous survey mode after a predetermined period of time.

Similar to the computing system 130, the computing system 330 may be used to process the continuous survey data acquired by the survey tool 320 during the outrun data acquisition, as further described below. In particular, based on the acquired data, the computing system 330 may be used to generate a continuous survey of the wellbore 312. The computing system 330 may be located at the surface, and may be configured to receive or download the recorded data from the tool 320 after the tool 320 has been retrieved from the wellbore 312 using any form of communications known to those skilled in the art. The computing system 330 can be any computing system implementation known to those skilled in the art. Various implementations of the computing system 330 and the computing system of the survey tool 320 are further discussed in a later section.

As noted above, in one implementation, the computing system 330 may use the continuous survey data to determine a toolface angle, an inclination angle, and azimuth for each survey station along the wellbore 312. In particular, the toolface angle, the inclination angle, and the azimuth of the wellbore 312 may be determined for each survey station using the equations discussed earlier. In a further implementation, the computing system may generate a continuous survey of the previously drilled section of the wellbore by plotting the determined azimuth and inclination angle versus depth for all of the survey stations. The continuous survey may then provide information regarding the trajectory, and thus tortuosity, of the previously drilled section of the wellbore.

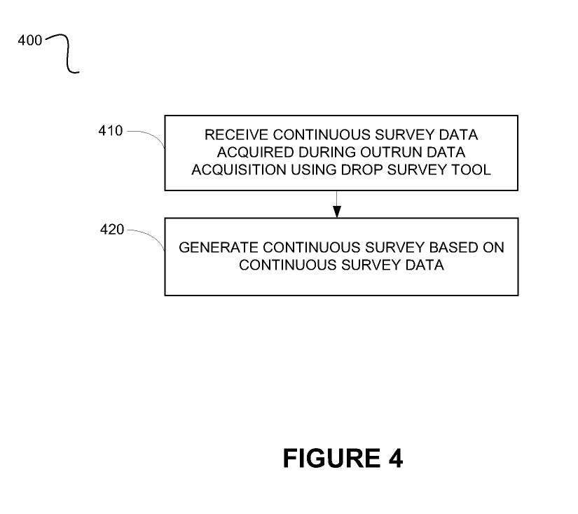

FIG. 4 illustrates a flow diagram of a method 400 for generating a continuous survey of a wellbore in accordance with implementations of various techniques described herein. In one implementation, method 400 may be at least partially performed by a computing system, such as the computing system 330 discussed above. It should be understood that while method 400 indicates a particular order of execution of operations, in some implementations, certain portions of the operations might be executed in a different order. Further, in some implementations, additional operations or steps may be added to the method 400. Likewise, some operations or steps may be omitted.

At block 410, the computing system may receive continuous survey data acquired during an outrun data acquisition of a previously drilled section of a wellbore using a drop survey tool, where the drop survey tool is configured to acquire the continuous survey data as the tool ascends within the previously drilled section of the wellbore during the outrun data acquisition. In particular, the continuous survey data may be data corresponding to a plurality of continuous survey measurements acquired during the outrun data acquisition.

As noted above, the survey tool may be configured to perform the outrun data acquisition as the drill string is being retrieved from the wellbore, during which the tool records continuous survey data at multiple survey stations within the wellbore and stores that data in an electronic memory device of the survey tool. As also noted above, the continuous survey data may be acquired at discrete intervals (i.e., survey stations) as the drill string is being retrieved from the wellbore. In one implementation, such intervals may be no greater than every 1 foot along the wellbore.

The continuous survey data may be acquired using one or more magnetic sensors, one or more accelerometers, and any other sensors of the survey tool. The continuous survey data also includes depth data acquired during the outrun data acquisition, where the depth data corresponds to depth of the survey tool at the survey stations for the continuous survey data. The depth data can be determined based on the known lengths of the drill string and of each section of the drill string that is pulled out during the retrieval process. In addition, prior to dropping the drop survey tool within the drill string, the survey tool may be switched to a continuous survey mode, during which the continuous survey data can be acquired.

At block 420, the computing system may generate a continuous survey of the previously drilled section of the wellbore based on the continuous survey data. In particular, as is known to those skilled in the art, the continuous survey data may be plotted to produce a continuous survey of the wellbore, where the continuous survey provides information regarding the trajectory, and thus tortuosity, of the wellbore. The continuous survey of the wellbore may provide information regarding the trajectory of the wellbore at the survey stations along the wellbore.

In one implementation, the continuous survey data may include multiple measurements for the same position within the wellbore, such as multiple magnetic survey measurements that were acquired when the drill string was momentarily stabilized at a particular position in the wellbore during the retrieval process. In such an implementation, the computing system may calculate an average of these multiple measurements, and then use this average when generating the continuous survey of the wellbore.

In another implementation, during an inrun data acquisition, the drop survey tool may record survey data as it falls within the drill string, and store that data in the electronic memory device of the survey tool. In such an implementation, and as similarly discussed above with respect to FIG. 2, the computing system may generate the continuous survey of the wellbore based on the continuous survey data acquired during the outrun data acquisition and the survey data acquired during the inrun data acquisition.

### Rotary Steerable System (RSS) Drilling Tool

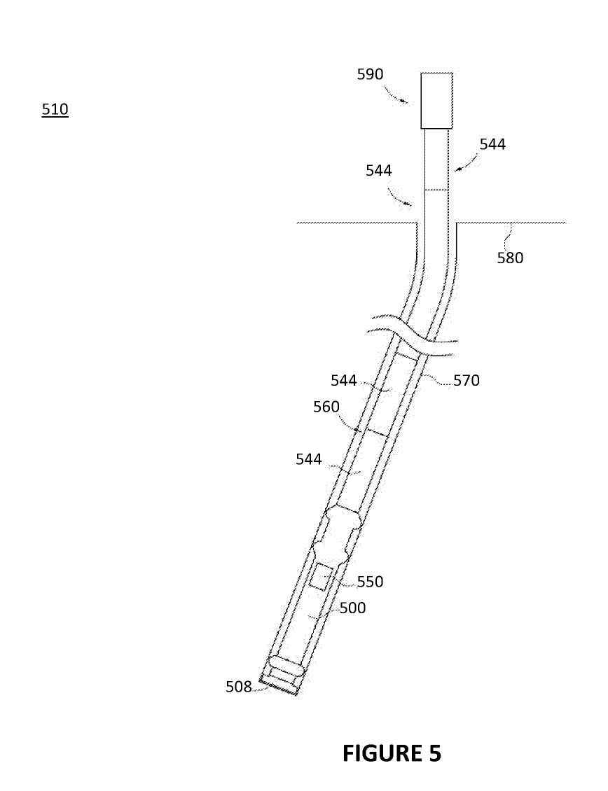

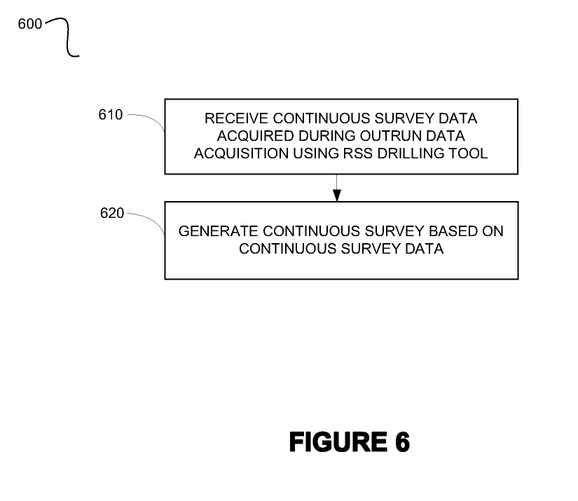

Various implementations directed to a continuous survey using survey sensors will now be described in the following paragraphs with reference to at least FIGS. 5-6.

In one implementation, and in a similar manner as the MWD tool discussed above with respect to FIGS. 1-2, a rotary steerable system (RSS) drilling tool disposed in a previously drilled section of the wellbore may be used to acquire continuous survey data during an outrun data acquisition. As described above, an outrun data acquisition may refer to a data acquisition performed as a survey tool is extracted from at least the previously drilled section of the wellbore. In the implementations further described below, during the outrun data acquisition, the RSS drilling tool may record the continuous survey data as it ascends within the previously drilled section of the wellbore. The continuous survey data may be used to generate a continuous survey of the wellbore, which may be used to determine the true path or trajectory of the wellbore.

A RSS drilling tool may be a type of directional drilling tool which allows for directional drilling of wellbores while allowing or maintaining rotation of a drill string. Such a tool may include steering mechanisms that enable controlled changes in wellbore direction, may allow for improved directional control, improved hole cleaning, improved borehole quality, and may generally minimize drilling problems as compared to earlier drilling technologies.

FIG. 5 illustrates a schematic diagram of a drilling operation 510 in accordance with implementations of various techniques described herein. As shown, the drilling operation 510 may be performed using a RSS drilling tool 500 and a computing system 590. The computing system 590 is described in further detail in a later section. The RSS drilling tool 500 may be part of a drill string 560 disposed within a wellbore 570, where the drill string 560 may also include one or more pipe segments 544 extending to the surface 580.

Various implementations of the RSS drilling tool 500 are known to those skilled in the art and may be used. In one implementation, the RSS drilling tool 500 may include a rotatable shaft (not shown) extending through the tool 500, where an end of the shaft may be coupled to a drill bit structure 508. In a further implementation, the RSS drilling tool 500 may also include a steering subsystem (not pictured), which may include one or more bearings, one or more actuators, and/or the like. As known in the art, the steering subsystem may be configured to angulate the rotatable shaft by exerting force using the one or more bearings and the one or more actuators, such as to steer the RSS drilling tool 500 and the drill bit structure 508 in a desired direction and/or to generate a wellbore trajectory with a desired curvature.

The RSS drilling tool 500 may further include one or more survey sensors 550, which may be used to acquire measurements while the drill string 560 is drilling the wellbore 570 and being extended downwardly along the wellbore 570. The survey sensors 550 may include any combination of one or more magnetic sensors, one or more accelerometers, and/or one or more gyroscopic sensors known to those skilled in the art. The RSS drilling tool 500 may also include any other sensors and/or instrumentation known to those skilled in the art.

Similar to the magnetic sensors described above with respect to FIGS. 1-4, the one or more magnetic sensors of the RSS drilling tool 500 can be any magnetic sensor known to those skilled in the art, including those mentioned above. In particular, as is known to those skilled in the art, the magnetic sensors may be used to measure the direction and magnitude of the local magnetic field vectors in order to measure the azimuth and/or the inclination at various survey stations along the wellbore 570, as is known to those skilled in the art. In particular, the magnetic sensors may be configured to measure one or more orthogonal and/or non-orthogonal components of the Earth's magnetic field. For example, the RSS drilling tool 500 may include three magnetic sensors configured to measure the orthogonal components (bₓ, b_{y}, b_{z}) of the Earth's magnetic field with respect to the x-axis, the y-axis, and the z-axis of the tool 500. The one or more magnetic sensors may include any magnetic sensor known to those skilled in the art, including flux gate sensors, solid state devices, and/or the like.

Similar to the accelerometers described above with respect to FIGS. 1-4, the one or more accelerometers of the RSS drilling tool 500 can be any accelerometer known to those skilled in the art, including those mentioned above. In particular, as is known to those skilled in the art, the one or more accelerometers may include three single-axis accelerometers configured to provide measurements of the orthogonal components (gₓ, g_{y}, g_{z}) of the Earth's gravitation vector with respect to the x, y, and z axes of the drilling tool 500.

The one or more gyroscopic sensors of the RSS drilling tool 500 can be any gyroscopic sensor known to those skilled in the art. In particular, as is known to those skilled in the art, the gyroscopic sensors may be configured to provide measurements of the Earth's rotation rate with respect to two or three orthogonal axes of the RSS drilling tool 500. The gyroscopic sensors may also be configured to provide measurements of change in inclination and azimuth of the RSS drilling tool 500 (i.e., orientation of the tool) over relatively short depth intervals. In one implementation, the one or more gyroscopic sensors may include three single-axis gyroscopic sensors or two dual-axis gyroscopic sensors, and may be used to provide measurements of the Earth's rotation rate with respect to the x, y, and z axes of the RSS drilling tool 500.

The gyroscopic sensors may include: a spinning mass gyroscopic sensor, such as a single-axis rate integrating gyroscopic sensor or a dual-axis dynamically tuned gyroscopic sensor; an optical gyroscopic sensor, such as a ring laser gyroscopic sensor (RLG) or a fiber-optic gyroscopic sensor (FOG); a Coriolis vibratory gyroscopic sensor, such as a tuning fork gyroscopic sensor or a hemispherical resonator gyroscopic sensor (HRG); a microelectromechanical system (MEMS) gyroscopic sensor; and/or any other implementation known to those skilled in the art. The one or more gyroscopic sensors may be capable of providing measurements of the Earth's rotation rate to the desired accuracy (e.g., in a range from 0.01°/hour to 0.05°/hour). The one or more gyroscopic sensors may be sufficiently small to be accommodated in a downhole tool (e.g., within the confines of a 1¾-inch pressure case of a wellbore), capable of operating over an expected temperature range (e.g., −20° Celsius (C) to +150° C., or greater), and/or capable of surviving the down hole vibration and shock environment that may be encountered during the drilling process.

As noted above, in conventional systems, the RSS drilling tool 500 may be a type of directional drilling tool which allows for directional drilling of wellbores while allowing for the, or the maintaining of the, rotation of the drill string 560. In particular, as is known in the art, the RSS drilling tool 500 may approximate the path of a wellbore by pointing or pushing the drill bit in a desired direction. Such a tool may be able to drill a curve or maintain a straight path for the wellbore. In addition, the RSS drilling tool 500 may be used to acquire survey data (i.e., stationary survey data) during an inrun data acquisition using its one or more survey sensors. As noted above, an inrun data acquisition may refer to a data acquisition performed as a survey tool is inserted into a wellbore. However, the situation downhole may not be known precisely, and failure of the RSS drilling tool 500 to become stationary when survey data are collected during the inrun data acquisition may degrade the accuracy of a wellbore survey generated using this survey data.

As such, various implementations described herein may be used to acquire continuous survey data during an outrun data acquisition using the RSS drilling tool 500, where the continuous survey data may be used to generate a continuous survey of a previously drilled section of the wellbore 570 in order to determine the true path or trajectory of the previously drilled section of the wellbore 570. The acquisition of the continuous survey data by the RSS drilling tool 500 differs from the acquisition of stationary survey data by the tool 500 in that, while acquiring the continuous survey data, the tool 500 is configured to measure changes in the orientation of the tool 500 and to the Earth's rotation rate. The measured changes in the orientation of the tool 500 can be integrated by a computing system (e.g. computing system 590) in order to generate a continuous survey (i.e., azimuth and inclination) of the wellbore 570.

In particular, after a period of drilling using the drill string has ceased, the RSS drilling tool 500 may be disposed in the previously drilled section of the wellbore 570. A portion of the drill string 560 may be retrieved thereafter, such as to inspect and/or repair a portion of the drill string 560. This retrieval process may also be referred to as a “tripping out of hole” procedure, by which the drill string 560, including downhole portions that include the drill bit 508 and the RSS drilling tool 500, is brought to the surface 580 a section of drill string 560 at a time.

As such, during the retrieval of the drill string 560, the RSS drilling tool 500 is raised within the wellbore 570 to the surface 580 or to a higher position within the wellbore 570, placing the RSS drilling tool 500 at multiple positions of different depths with respect to the Earth as the drill string 560 ascends the wellbore 570.

Accordingly, the RSS drilling tool 500 may be configured to acquire continuous survey data during an outrun data acquisition as the drill string 560 is being retrieved from the wellbore 570, during which the tool 500 may record the continuous survey data at the multiple positions (i.e., survey stations) within the wellbore 570 and store that data in an electronic memory device (not pictured) of the RSS drilling tool 500. The data recorded by the tool 500 as the tool 500 ascends the wellbore 570 may correspond to continuous survey measurements acquired using the one or more survey sensors described above.

In particular, the survey data may be acquired using these sensors at discrete intervals (i.e., survey stations) as the drill string 560 is being retrieved from the wellbore 570. Although the survey data is acquired at discrete intervals, the discrete intervals may be set to a value such that the survey data effectively corresponds to “continuous” survey data for a previously drilled section of the wellbore 570. As such, the survey data acquired using the implementations discussed herein are referred to as “continuous survey data”.

For example, the discrete intervals may be set to be no greater than every one foot along the wellbore 570. In other examples, discrete intervals of three feet, five feet, and so forth may be used. A data sampling (i.e., acquisition) frequency of the RSS drilling tool 500 may be set to a particular value in order to assure that the tool 500 acquires the continuous survey data at particular discrete intervals (e.g. every one foot). The setting of the data sampling frequency of the tool 500 may depend on the rate of ascent of the tool 500 within the drill string 560. In particular, the faster that the tool 500 moves within the drill string 560, the higher the data sampling frequency should be in order to assure that the tool 500 acquires the continuous survey data at the particular discrete intervals.

In one implementation, the continuous survey data may be used to determine a toolface angle, an inclination angle, and azimuth for each survey station along the wellbore 570 as the tool 500 ascends within the wellbore 570. In another implementation, the continuous survey data may include measured changes in inclination and azimuth between each survey station along the wellbore as the tool 500 ascends within the wellbore 570.

In addition, the continuous survey data also includes depth data acquired by the RSS drilling tool 500 during the outrun data acquisition. In one implementation, the depth of the RSS drilling tool 500 (i.e., the depth data) at the survey stations for the continuous survey data recorded during the outrun data acquisition can be determined based on the known lengths of the drill string 560 and of each section of the drill string 560 that is pulled out during the retrieval process.

In one such implementation, in addition to the known lengths of the drill string 560 and of each section of the drill string 560 that is pulled out during the retrieval process, the depth of the RSS drilling tool 500 (i.e., the depth data) at the survey stations can be determined based on the assumption that the rate of ascent of the drill string 560 during retrieval is substantially constant, particularly between the multiple stationary positions at which the RSS drilling tool 500 is placed during the retrieval process described above.

In particular, as is known in the art, the drill string 560 may be composed of multiple sections threadably coupled together. As such, during retrieval, one section of the drill string 560 is pulled out of the wellbore (i.e., recovered), and movement of the drill string 560 is momentarily stabilized. The recovered section of the drill string 560 is then unthreaded from the drill string 560, and the same retrieval process is repeated for subsequent sections of the drill string. Thus, during the retrieval of the drill string 560, the RSS drilling tool 500 positioned at the bottom of the drill string 560 is slowly raised within the wellbore 570 and placed in multiple stationary positions of different depths with respect to the Earth (i.e., each time a section of the drill string 560 is unthreaded). As such, the rate of ascent of the drill string 560 during retrieval between the multiple stationary positions may be substantially constant, which, when combined with the known lengths of the drill string 560 and of each section of the drill string 560 that is pulled out during the retrieval process, can be used to determine the depth data of the tool 500 at the survey stations for the continuous survey data.

In another implementation, in addition to the known lengths of the drill string 560 and of each section of the drill string 560 that is pulled out during the retrieval process, the depth of the RSS drilling tool 500 (i.e., the depth data) at the survey stations can also be determined using the one or more accelerometers. In particular, the one or more accelerometers may include a z-axis accelerometer configured to provide measurements of the acceleration along a longitudinal axis (i.e., z-axis) of the RSS drilling tool 500. As such, the z-axis accelerometer may be used to determine the depth of the RSS drilling tool 500 at the survey stations for the continuous survey data, irrespective of the rate of ascent for the tool 500 during retrieval. Specifically, the measurements acquired using the z-axis accelerometer may be integrated in order to determine the depth of the RSS drilling tool 500 at the survey stations.

In one implementation, prior to the retrieval of the RSS drilling tool 500, a computing system (not shown) of the RSS drilling tool 500 may receive a mode signal indicating that the tool 500 is to switch to a continuous survey mode, during which the continuous survey data can be acquired. In a further implementation, the computing system 590 may transmit the mode signal to the computing system of the RSS drilling tool 500. The computing system 590 is discussed in further detail in a later section.

The mode signal may be communicated to the RSS drilling tool 500 using any form of downhole communication known to those skilled in the art. In one implementation, the mode signal may be transmitted to the RSS drilling tool 500 using mud pulse telemetry. For example, the computing system 590 may use a pulser unit to transmit the mode signal by varying the drilling fluid (mud) pressure inside the drill string. Downhole pressure transducers may measure these pressure fluctuations (pulses) and pass an analog form of the mode signal to the computing system of the RSS drilling tool 500, where the received analog signal may be digitized. Other forms of downhole communication used to transmit the mode signal to the computing system of the RSS drilling tool 500 may include any form of electromagnetic communication, acoustic communication, and/or the like known to those skilled in the art.

In some implementations, the RSS drilling tool 500 may initially be in a stationary survey mode, during which the RSS drilling tool 500 is configured to acquire stationary survey data during the inrun data acquisition. In such implementations, the mode signal may be used to switch the RSS drilling tool 500 from the stationary survey mode to the continuous survey mode prior to the retrieval of the RSS drilling tool 500 and the outrun data acquisition.

As explained above, the computing system 590 may be used to process the data acquired by the RSS drilling tool 500 during the outrun data acquisition. In particular, based on the acquired data, the computing system 590 may be used to generate a continuous survey of the wellbore 570. As noted above, in one implementation, the computing system 590 may use the continuous survey data to determine a toolface angle, an inclination angle, and azimuth for each survey station along the wellbore 570. In a further implementation, the computing system may generate a continuous survey of the previously drilled section of the wellbore 570 by plotting the determined azimuth and inclination angle versus depth for all of the survey stations. The continuous survey may then provide information regarding the trajectory, and thus tortuosity, of the previously drilled section of the wellbore 570.

As shown in FIG. 5, the computing system 590 may be included in the drill string 560, and may be configured to control and/or monitor the operation of the drill string 560 or portions thereof. The computing system 590 can be configured to perform a variety of functions. For example, the computing system 590 can be adapted to determine the current orientation or the trajectory of the drilling tool 500 within the wellbore 570.

In one implementation, the computing system 590 may be located at or above the Earth's surface 580, and may be communicatively coupled to the on-board computing system. The computing system 590 may be configured to receive or download the recorded data from the tool 500 after the tool 500 has been retrieved from the wellbore 570 using any form of communications known to those skilled in the art. In another implementation, the computing system 590 may be configured to receive or download the acquired data from the tool 500 in real-time or near real-time as the tool 500 traverses the wellbore 570.

Further, the computing system 590 may be communicatively coupled to the on-board computing system of the tool 500 using mud pulse telemetry, electromagnetic (EM) telemetry, or any form of communication know to those skilled in the art. In some implementations where at least a portion of the computing system 590 is located at or above the Earth's surface, the computing system 590 may be coupled to a downhole portion of the drill string 560 (e.g., to the on-board computing system of the tool 500, to the sensors located within the tool 500, and/or the like) by a wire or cable extending along the drill string 560. In another implementation, the drill string 560 may include signal conduits through which signals are transmitted from the downhole portion of the drill string 560 (e.g., from the on-board computing system of the tool 500 or from sensors located within the tool 500) to the computing system 590. In such an implementation, the drill string 560 may be adapted to transmit control signals from the computing system 590 to the downhole portion of the drill string 560.

The computing system 590 can include any computing system implementation known to those skilled in the art. Various implementations of the computing system 590 and the on-board computing system of the RSS drilling tool 500 are further discussed in a later section.

FIG. 6 illustrates a flow diagram of a method 600 for generating a continuous survey of a wellbore in accordance with implementations of various techniques described herein. In one implementation, method 600 may be at least partially performed by a computing system, such as the computing system 590 discussed above. It should be understood that while method 600 indicates a particular order of execution of operations, in some implementations, certain portions of the operations might be executed in a different order. Further, in some implementations, additional operations or steps may be added to the method 600. Likewise, some operations or steps may be omitted.

At block 610, the computing system may receive continuous survey data acquired during an outrun data acquisition of a previously drilled section of a wellbore using a RSS drilling tool, where the RSS drilling tool is configured to acquire the continuous survey data as the tool ascends within the previously drilled section of the wellbore during the outrun data acquisition. In particular, the continuous survey data may be data that corresponds to a plurality of continuous survey measurements acquired during the outrun data acquisition.

As noted above, the RSS drilling tool may be configured to perform the outrun data acquisition as the drill string is being retrieved from the wellbore, during which the tool records continuous survey data at multiple survey stations within the wellbore and stores that data in an electronic memory device associated with an on-board computing system of the drilling tool. As also noted above, the continuous survey data may be acquired at discrete intervals (i.e., survey stations) as the drill string is being retrieved from the wellbore. In one implementation, such intervals may be no greater than every 1 foot along the wellbore.

The continuous survey data may be acquired using one or more survey sensors of the RSS drilling tool. The survey sensors may include any combination of one or more magnetic sensors, one or more accelerometers, and/or one or more gyroscopic sensors known to those skilled in the art. The continuous survey data also includes depth data acquired during the outrun data acquisition, where the depth data corresponds to depth of the RSS drilling tool at the survey stations for the continuous survey data. The depth data can be determined based on the known lengths of the drill string and of each section of the drill string that is pulled out during the retrieval process. In addition, prior to the retrieval of the RSS drilling tool, an on-board computing system of the RSS drilling tool may receive a mode signal indicating that the RSS drilling tool is to switch to a continuous survey mode, during which the continuous survey data can be acquired.

At block 620, the computing system may generate a continuous survey of the previously drilled section of the wellbore based on the continuous survey data. In particular, as is known to those skilled in the art, the continuous survey data may be plotted to produce a continuous survey of the wellbore, where the continuous survey provides information regarding the trajectory, and thus tortuosity, of the wellbore. The continuous survey of the wellbore may provide information regarding the trajectory of the wellbore at the survey stations along the wellbore.

In another implementation, the continuous survey data may also include multiple measurements for the same position within the wellbore. As noted above, multiple survey measurements may be acquired using the one or more survey sensors when the drill string is momentarily stabilized at a particular position in the wellbore during the retrieval process. In such an implementation, the computing system may calculate an average of these multiple measurements, and then use this average when generating the continuous survey of the wellbore.

In another implementation, the computing system may generate the continuous survey of the wellbore based on the continuous survey data acquired during the outrun data acquisition and the stationary survey data acquired during the inrun data acquisition. Any implementation for generating the continuous survey based on the continuous survey data and the stationary survey data may be used, such as the method for combining the continuous survey data and the stationary survey data disclosed in commonly assigned U.S. patent application Ser. No. 14/446,140, which is herein incorporated by reference.

As mentioned above, continuous surveys may be subject to measurement drifts, which can propagate and increase in size over long wellbore sections and lead to inaccuracies in inclination and azimuth. In a further implementation, the stationary survey data acquired during drilling (i.e., the inrun data acquisition), either from the RSS drilling tool or from a MWD survey tool, can be combined with the continuous survey data acquired during the retrieval process (i.e., the outrun data acquisition) in order to correct possible gyro drift of the continuous survey data. In implementations using the MWD survey tool to acquire the stationary survey data, any implementation of a MWD survey tool may be used, including the MWD survey tool discussed above with respect to FIGS. 1-2. In another implementation, the MWD survey tool may include any combination of one or more magnetic sensors, one or more accelerometers, and/or one or more gyroscopic sensors known to those skilled in the art.

In yet another implementation, the RSS drilling tool discussed above may be used instead of, or in conjunction with, a MWD survey tool. In such an implementation, any implementation of a MWD survey tool may be used, including the MWD survey tool discussed above with respect to FIGS. 1-2. In particular, the RSS drilling tool may use its one or more survey sensors to acquire continuous survey data during an outrun data acquisition. In such implementations, it may not be necessary to use the MWD survey tool to acquire continuous survey data during an outrun data acquisition. However, in other implementations, the MWD survey tool may also be used with the RSS drilling tool to acquire additional continuous survey data during an outrun data acquisition.

As noted above, it can be desirable to use a continuous survey of a wellbore to more accurately determine the true path or trajectory of a previously drilled wellbore. An accurate determination of the trajectory of a wellbore can be used in the final positioning of the wellbore, the identification of low-tortuosity sections for permanent installation of completion or production equipment, and the identification of high-tortuosity sections in which rod guide wear sleeve equipment is to be placed to increase rod and casing life and to reduce workover frequency. Furthermore, detailed knowledge of well tortuosity may help the evaluation of the drilling equipment and process, in particular the steering while drilling performance, and for extended reach drilling.

For example, the tortuosity information can be helpful in determining where to place one or more pumps in the wellbore. The placement of a pump in a wellbore section having a relatively high tortuosity can reduce the lifetime of the pump dramatically. If installed in a higher-tortuosity section of the wellbore, the pump may be subject to a bending moment due to the shape of the wellbore restricting the ability of the pump rotor to turn freely (e.g., as a result of excess pressure on the bearings or sliding contact between the rotor and the outer casing of the pump), causing the pump to wear out sooner than had the pump been installed in a lower-tortuosity section of the wellbore.

The implementations described above with respect to FIGS. 1-6 may also be used in conjunction with other methods for analyzing the tortuous sections of a wellbore, such as the implementations described in commonly-assigned U.S. patent application Ser. Nos. 14/612,162 and 14/612,168, both of which are herein incorporated by reference.

In sum, implementations relating to generating a continuous survey of a wellbore may be used to more accurately determine the true path or trajectory of a previously drilled wellbore. This may be particularly important for wellbores containing severe high dog-legs and sections of high tortuosity, where failure to capture such details of trajectory can lead to errors in knowledge of well locations. As noted above, an accurate determination of the trajectory of a wellbore can be used in the final positioning of the wellbore, the identification of low-tortuosity sections for permanent installation of completion or production equipment, and the identification of high-tortuosity sections in which rod guide wear sleeve equipment is to be placed to increase rod and casing life and to reduce workover frequency.

### Computing System

Various implementations of the previously-discussed computing systems are further discussed below. Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, smart watches, personal wearable computing systems networked with other computing systems, tablet computers, and distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. While program modules may execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. The distributed computing environments may span multiple continents and multiple vessels, ships or boats. In a distributed computing environment, program modules may be located in both local and remote computer storage media including memory storage devices.

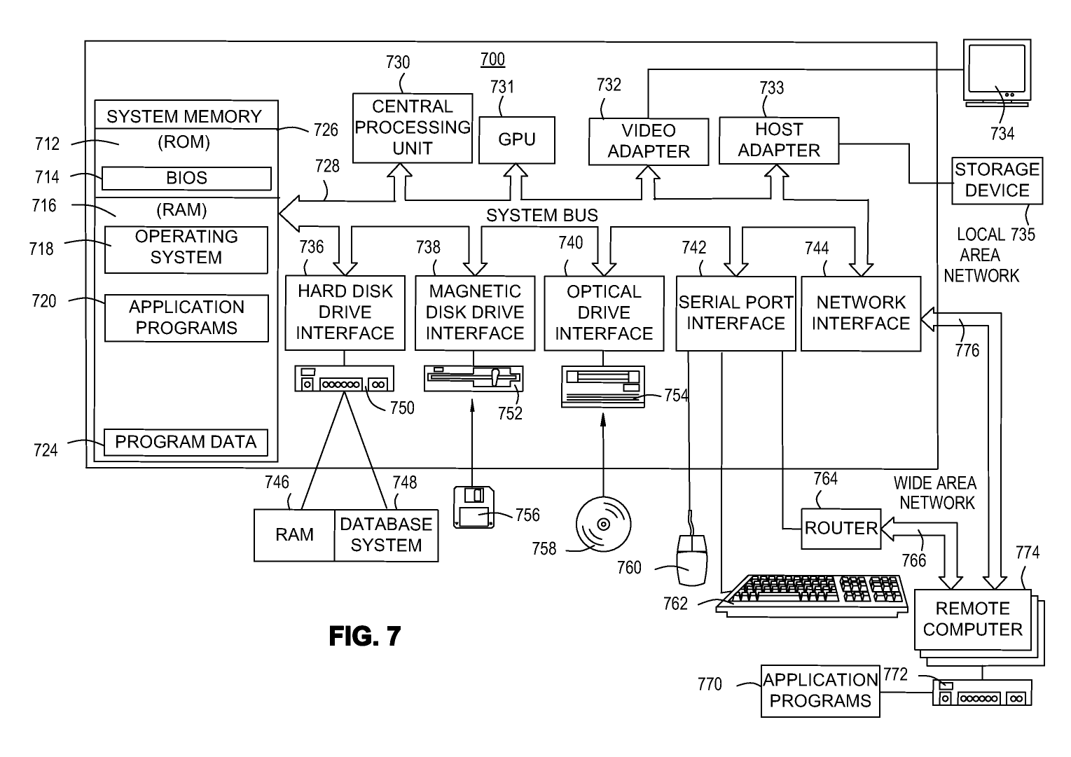

FIG. 7 illustrates a schematic diagram of a computing system 700 in which the various technologies described herein may be incorporated and practiced. Although the computing system 700 may be a conventional desktop or a server computer, as described above, other computer system configurations may be used.

The computing system 700 may include a central processing unit (CPU) 730, a system memory 726, a graphics processing unit (GPU) 731 and a system bus 728 that couples various system components including the system memory 726 to the CPU 730. Although one CPU is illustrated in FIG. 7, it should be understood that in some implementations the computing system 700 may include more than one CPU. The GPU 731 may be a microprocessor specifically designed to manipulate and implement computer graphics. The CPU 730 may offload work to the GPU 731. The GPU 731 may have its own graphics memory, and/or may have access to a portion of the system memory 726. As with the CPU 730, the GPU 731 may include one or more processing units, and the processing units may include one or more cores. The system bus 728 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 726 may include a read-only memory (ROM) 712 and a random access memory (RAM) 746. A basic input/output system (BIOS) 714, containing the basic routines that help transfer information between elements within the computing system 700, such as during start-up, may be stored in the ROM 712.

The computing system 700 may further include a hard disk drive 750 for reading from and writing to a hard disk, a magnetic disk drive 752 for reading from and writing to a removable magnetic disk 756, and an optical disk drive 754 for reading from and writing to a removable optical disk 758, such as a CD ROM or other optical media. The hard disk drive 750, the magnetic disk drive 752, and the optical disk drive 754 may be connected to the system bus 728 by a hard disk drive interface 756, a magnetic disk drive interface 758, and an optical drive interface 750, respectively. The drives and their associated computer-readable media may provide nonvolatile storage of computer-readable instructions, data structures, program modules and other data for the computing system 700.

Although the computing system 700 is described herein as having a hard disk, a removable magnetic disk 756 and a removable optical disk 758, it should be appreciated by those skilled in the art that the computing system 700 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 700. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 700 may also include a host adapter 733 that connects to a storage device 735 via a small computer system interface (SCSI) bus, a Fiber Channel bus, an eSATA bus, or using any other applicable computer bus interface. Combinations of any of the above may also be included within the scope of computer readable media.

A number of program modules may be stored on the hard disk 750, magnetic disk 756, optical disk 758, ROM 712 or RAM 716, including an operating system 718, one or more application programs 720, program data 724, and a database system 748. The application programs 720 may include various mobile applications (“apps”) and other applications configured to perform various methods and techniques described herein. The operating system 718 may be any suitable operating system that may control the operation of a networked personal or server computer, such as Windows® XP, Mac OS® X, Unix-variants (e.g., Linux® and BSD®), and the like.

A user may enter commands and information into the computing system 700 through input devices such as a keyboard 762 and pointing device 760. Other input devices may include a microphone, joystick, game pad, satellite dish, scanner, or the like. These and other input devices may be connected to the CPU 730 through a serial port interface 742 coupled to system bus 728, but may be connected by other interfaces, such as a parallel port, game port or a universal serial bus (USB). A monitor 734 or other type of display device may also be connected to system bus 728 via an interface, such as a video adapter 732. In addition to the monitor 734, the computing system 700 may further include other peripheral output devices such as speakers and printers.

Further, the computing system 700 may operate in a networked environment using logical connections to one or more remote computers 774. The logical connections may be any connection that is commonplace in offices, enterprise-wide computer networks, intranets, and the Internet, such as local area network (LAN) 756 and a wide area network (WAN) 766. The remote computers 774 may be another a computer, a server computer, a router, a network PC, a peer device or other common network node, and may include many of the elements describes above relative to the computing system 700. The remote computers 774 may also each include application programs 770 similar to that of the computer action function.

When using a LAN networking environment, the computing system 700 may be connected to the local network 776 through a network interface or adapter 744. When used in a WAN networking environment, the computing system 700 may include a router 764, wireless router or other means for establishing communication over a wide area network 766, such as the Internet. The router 764, which may be internal or external, may be connected to the system bus 728 via the serial port interface 752. In a networked environment, program modules depicted relative to the computing system 700, or portions thereof, may be stored in a remote memory storage device 772. It will be appreciated that the network connections shown are merely examples and other means of establishing a communications link between the computers may be used.

The network interface 744 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 774.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Also, the program code may execute entirely on a user's computing device, on the user's computing device, as a stand-alone software package, on the user's computer and on a remote computer or entirely on the remote computer or a server computer.

The system computer 700 may be located at a data center remote from the survey region. The system computer 700 may be in communication with the receivers (either directly or via a recording unit, not shown), to receive signals indicative of the reflected seismic energy. These signals, after conventional formatting and other initial processing, may be stored by the system computer 700 as digital data in the disk storage for subsequent retrieval and processing in the manner described above. In one implementation, these signals and data may be sent to the system computer 700 directly from sensors, such as geophones, hydrophones and the like. When receiving data directly from the sensors, the system computer 700 may be described as part of an in-field data processing system. In another implementation, the system computer 700 may process seismic data already stored in the disk storage. When processing data stored in the disk storage, the system computer 700 may be described as part of a remote data processing center, separate from data acquisition. The system computer 700 may be configured to process data as part of the in-field data processing system, the remote data processing system or a combination thereof.

Those with skill in the art will appreciate that any of the listed architectures, features or standards discussed above with respect to the example computing system 700 may be omitted for use with a computing system used in accordance with the various embodiments disclosed herein because technology and standards continue to evolve over time.

While the foregoing is directed to implementations of various technologies described herein, other and further implementations may be devised without departing from the basic scope thereof. Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Depending on the embodiment, certain acts, events, or functions of any of the methods described herein can be performed in a different sequence, can be added, merged, or left out completely (e.g., not all described acts or events are necessary for the practice of the method). Moreover, in certain embodiments, acts or events can be performed concurrently, e.g., through multi-threaded processing, interrupt processing, or multiple processors or processor cores, rather than sequentially.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of computer-readable storage medium known in the art. An exemplary tangible, computer-readable storage medium is coupled to a processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A method, comprising:
acquiring continuous survey data during an outrun data acquisition using one or more survey sensors of a rotary steerable system (RSS) drilling tool disposed within a previously drilled section of a wellbore, wherein the RSS drilling tool is configured to ascend within the previously drilled section of the wellbore during the outrun data acquisition; and
transmitting the continuous survey data to a computing system, wherein the computing system is configured to generate a continuous survey of the previously drilled section of the wellbore based on the continuous survey data.

2. The method of claim 1, wherein acquiring the continuous survey data comprises acquiring the continuous survey data during the outrun data acquisition as a drill string containing the RSS drilling tool is being retrieved from the previously drilled section of the wellbore.

3. The method of claim 1, wherein the one or more survey sensors comprise one or more gyroscopic sensors, one or more magnetic sensors, one or more accelerometers, or combinations thereof.

4. The method of claim 1, wherein acquiring the continuous survey data comprises acquiring the continuous survey data at depth intervals along the previously drilled section of the wellbore that are less than or equal to one foot.

5. The method of claim 1, wherein the continuous survey data comprises depth data acquired during the outrun data acquisition based on a length of a drill string containing the RSS drilling tool, a length of each section of the drill string, and a substantially constant rate of ascent of the RSS drilling tool between a plurality of stationary positions at which the RSS drilling tool is placed during a retrieval process.

6. The method of claim 1, further comprising:
receiving a mode signal at the RSS drilling tool disposed within the previously drilled section of the wellbore; and
switching the RSS drilling tool to a continuous survey mode based on the received mode signal.

7. The method of claim 6, wherein receiving the mode signal comprises receiving the mode signal at the RSS drilling tool using mud pulse telemetry.

8. The method of claim 1, wherein transmitting the continuous survey data comprises transmitting the continuous survey data to the computing system after the RSS drilling tool has been retrieved from the previously drilled section of the wellbore.

9. The method of claim 1, further comprising:
acquiring additional survey data during an inrun data acquisition using the RSS drilling tool; and
transmitting the additional survey data to the computing system, wherein the computing system is configured to generate the continuous survey of the previously drilled section of the wellbore based on the continuous survey data and the additional survey data.

10. A method, comprising:
receiving continuous survey data acquired during an outrun data acquisition using one or more survey sensors of a rotary steerable system (RSS) drilling tool disposed within a previously drilled section of a wellbore, wherein the RSS drilling tool is configured to ascend within the previously drilled section of the wellbore during the outrun data acquisition; and
generating a continuous survey of the previously drilled section of the wellbore based on the continuous survey data.

11. The method of claim 10, wherein the one or more survey sensors comprise one or more gyroscopic sensors, one or more magnetic sensors, one or more accelerometers, or combinations thereof.

12. The method of claim 10, wherein, during the outrun data acquisition, the RSS drilling tool is configured to acquire the continuous survey data as a drill string containing the RSS drilling tool is being retrieved from the previously drilled section of the wellbore.

13. The method of claim 10, wherein, during the outrun data acquisition, the RSS drilling tool is configured to acquire the continuous survey data at depth intervals along the previously drilled section of the wellbore that are less than or equal to one foot.

14. The method of claim 10, wherein the continuous survey data comprises depth data acquired during the outrun data acquisition based on a length of a drill string containing the RSS drilling tool, a length of each section of the drill string, and one or more measurements from a z-axis accelerometer of the RSS drilling tool.

15. The method of claim 10, wherein the RSS drilling tool is configured to:
receive a mode signal prior to the outrun data acquisition; and
switch to a continuous survey mode based on the received mode signal.

16. The method of claim 15, wherein the RSS drilling tool is configured to receive the mode signal using mud pulse telemetry.

17. The method of claim 10, further comprising:
receiving additional survey data acquired during an inrun data acquisition using the RSS drilling tool; and
generating a continuous survey of the previously drilled section of the wellbore based on the continuous survey data and the additional survey data.

18. A rotary steerable system (RSS) drilling tool disposed in a previously drilled section of a wellbore, comprising:
one or more survey sensors configured to acquire continuous survey data during an outrun data acquisition, wherein the RSS drilling tool is configured to ascend within the previously drilled section of the wellbore during the outrun data acquisition;
a processor; and
a memory comprising a plurality of program instructions which, when executed by the processor, cause the processor to:
transmit the continuous survey data to a computing system, wherein the computing system is configured to generate a continuous survey of the previously drilled section of the wellbore based on the continuous survey data.

19. The RSS drilling tool of claim 18, wherein the plurality of program instructions further comprise program instructions which, when executed by the processor, cause the processor to:
receive a mode signal prior to the outrun data acquisition; and
switch to a continuous survey mode based on the received mode signal.

20. The RSS drilling tool of claim 18, wherein:
the one or more survey sensors are further configured to acquire additional survey data during an inrun data acquisition; and
the memory further comprise program instructions which, when executed by the processor, cause the processor to transmit the additional survey data to the computing system, wherein the computing system is configured to generate the continuous survey of the previously drilled section of the wellbore based on the continuous survey data and the additional survey data.
